(19) United States
(12) Patent Application Publication
(10) Pub. No.: US 2025/0315039 A1
(43) Pub. Date: Oct. 9, 2025

(54) PLANT MONITORING SUPPORT APPARATUS, PLANT MONITORING SUPPORT METHOD, AND PLANT MONITORING SUPPORT PROGRAM

(71) Applicants: KABUSHIKI KAISHA TOSHIBA, Tokyo (JP); TOSHIBA ENERGY SYSTEMS & SOLUTIONS CORPORATION, Kawasaki-shi (JP)

(72) Inventors: Naoyuki TAKADO, Machida (JP); Toshio AOKI, Chigasaki (JP); Shinya TOMINAGA, Yokohama (JP); Ryota MIYAKE, Yokohama (JP)

(73) Assignees: KABUSHIKI KAISHA TOSHIBA, Tokyo (JP); TOSHIBA ENERGY SYSTEMS & SOLUTIONS CORPORATION, Kawasaki-shi (JP)

(21) Appl. No.: 19/015,186

(22) Filed: Jan. 9, 2025

(30) Foreign Application Priority Data
Apr. 4, 2024 (JP) 2024-060564

(51) Int. Cl. G05B 23/02

(52) U.S. Cl. CPC G05B 23/0289

(57) ABSTRACT

The plant monitoring support apparatus includes: an acquisition unit that acquire process values of a monitoring target; a reproduction unit that output a reproduced value obtained by using a model for performing data compression on the process values acquired in real time and data restoration on the compressed data; a first calculation unit that calculate deviations of the process values and the reproduced value; a detection unit that detect an anomaly sign of the monitoring target on the basis of a preset threshold and the deviations; a second calculation unit that calculate change amount of the deviations on the basis of a timing at which the anomaly sign is detected; and a selection unit that select a process value that belongs to another attribute and interrelated to the anomaly.

### CROSS-REFERENCE TO RELATED APPLICATIONS

This application is based upon and claims the benefit of priority from Japanese Patient application No. 2024-060564, filed on Apr. 4, 2024, the entire contents of each of which are incorporated herein by reference.

### FIELD

Embodiments of the present invention relate to a plant monitoring support technology that utilizes artificial intelligence (AI) to detect an anomaly sign.

### BACKGROUND

In the case of introducing the plant monitoring support technology in which AI-based anomaly sign detection has been put to practical use, it is important not only to detect an anomaly sign early but also to be able to analyze the causes and take action quickly. Furthermore, there is a need for such a plant monitoring support technology to visualize process values related to the detected anomaly.

Process values are outputted by a large number of sensors provided for detecting the states of the constituent components of the plant and are also outputted by a monitoring control device, and these process values are centrally managed in a central monitoring room, for example. In a power plant, a wide variety of process values are monitored in real time to check its operating state. When an anomaly sign is detected in a specific process value, other closely related process values are also monitored at the same time, and then the causes of the detected anomaly sign and its influence on the operating state of the plant are investigated.

Because specifying such closely related process values is difficult for human judgment due to enormous number of targets, mechanical methods for narrowing them down are being considered. In order to achieve this, in a known technique, two data assumed to have a causal relationship are set as input data and output data, and the narrowing-down processing is performed on the basis of response characteristics of the output data with respect to the input data. In this case, the response characteristics of the output data with respect to non-stationary change such as increase, decrease, and fluctuation of the input data are narrowed down for each type of change.

In another known technique, when a deviation between “a predicted value calculated from normal data” and the process value to be monitored exceeds a threshold, it is detected by AI as an anomaly sign. In this case, it is also disclosed that the trend of change in the deviation is visualized and simple rank correlation coefficients between process values are ranked and displayed.

However, in the above-described known techniques, in the case of extracting at least one process value which is related to an anomalous event or is to be influenced by the anomalous event, the extraction accuracy is so low as to cause four problems as follows.

Firstly, even if the trend of change in the deviation is visualized, it is difficult to extract at least one process value related to anomalies from among many process values.

Secondly, when the simple rank correlation coefficients are displayed as ranking, process values that stationarily change or have a large deviation are displayed at the top side of the ranking even though these process values are unrelated to anomalies.

Thirdly, the ranking changes due to minute change for the process values such as signal noise and pump pulsation.

Fourthly, it is difficult to take into account that process values related to an anomaly change with time delay.

### SUMMARY OF THE INVENTION

In view of the above-described circumstances, embodiments of the present invention aim to provide a plant monitoring support technique that can efficiently and highly reliably narrow down process values related to an anomalous event.

### BRIEF DESCRIPTION OF THE DRAWINGS

In the accompanying drawings:

FIG. 1 is a configuration diagram illustrating a plant monitoring support apparatus according to the first embodiment of the present invention;

FIG. 2 is a graph illustrating a time series of deviations to be outputted by a first calculation unit;

FIG. 3 is a screen displaying attributes and change amounts of process values that are mutually interrelated by an anomaly;

FIG. 4 is a configuration diagram illustrating the plant monitoring support apparatus according to the second embodiment;

FIG. 5 is a configuration diagram illustrating the plant monitoring support apparatus according to the third embodiment; and

FIG. 6 is a flowchart illustrating steps of a plant monitoring support method and algorithm of a plant monitoring support program.

### DETAILED DESCRIPTION

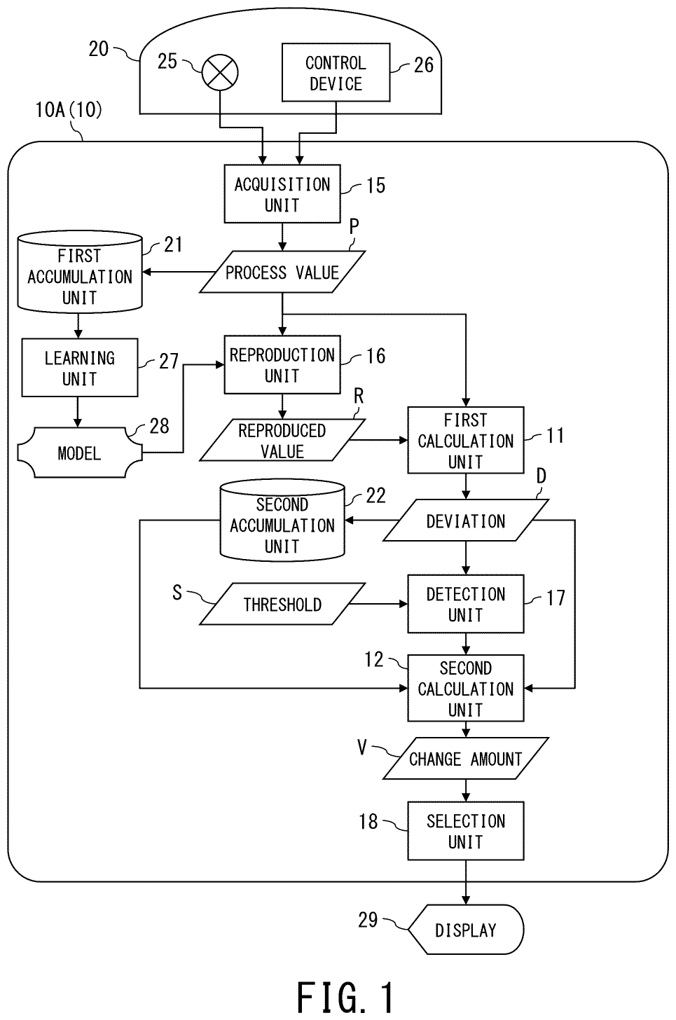

Hereinbelow, embodiments of the present invention will be described by referring to the accompanying drawings. FIG. 1 is a configuration diagram illustrating a plant monitoring support apparatus 10A (10) according to the first embodiment of the present invention.

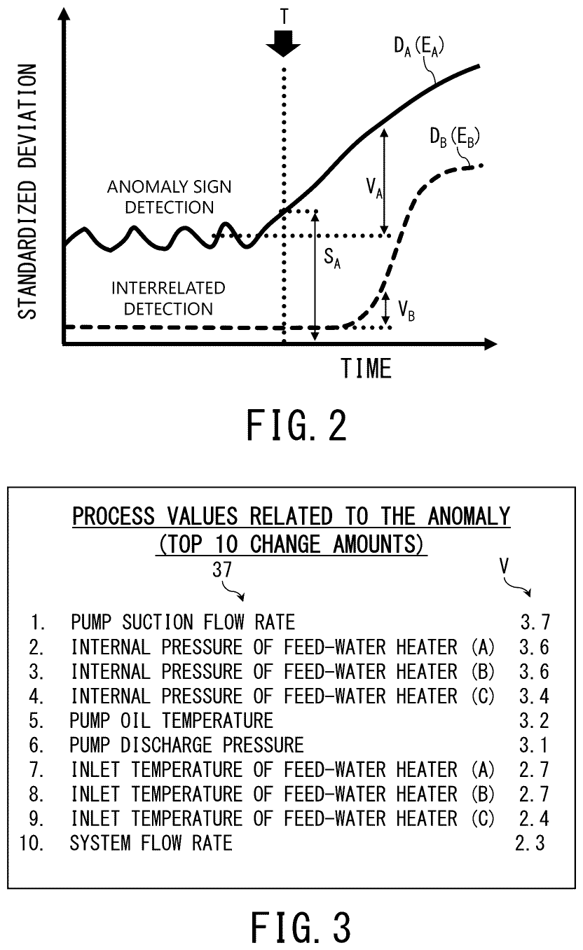

The plant monitoring support apparatus 10A includes: an acquisition unit 15 configured to acquire process values P of a monitoring target 20; a reproduction unit 16 configured to output a reproduced value R obtained by using a model 28 for performing (a) data compression on the process values P acquired in real time and (b) data restoration on the compressed data (hereinafter abbreviated as data compression/restoration); a first calculation unit 11 configured to calculate deviations D of the process values P and the reproduced value R; a detection unit 17 configured to detect an anomaly sign of the monitoring target 20 on the basis of a preset threshold S and the deviations D; a second calculation unit 12 configured to calculate change amount V of the deviations D on the basis of a timing T (FIG. 2) at which the anomaly sign is detected; and a selection unit 18 configured to select a process value P that belongs to another attribute and interrelated to the anomaly sign on the basis of the change amount V.

A plant serving as the monitoring target 20 is provided with a large number of sensors 25 for detecting respective states of its constituent components. Specifically, the process values P to be outputted by the sensors 25 include temperature, pressure, water level (displacement), flow velocity (speed), and acceleration, for example. Furthermore, in a complicated monitoring target 20 such as a nuclear power plant, the process values P are also inputted and outputted to a large number of installed control devices 26. Such control devices 26 include a power pump, a power cylinder, and a valve, for example.

The operating state of the plant is monitored by centrally managing these process values P in a central monitoring room. In a power plant, process values P with a wide variety of attributes are monitored in real time. When an anomaly sign is detected in a specific process value P, other closely interrelated process values P are also monitored at the same time in order to check the causes of the anomaly detection and/or the influence of the anomaly sign on the plant.

The acquisition unit 15 acquires a plurality of process values P of the monitoring target 20 in real time as time series data. Of the process values P acquired from the sensors 25 and the control devices 26, analog signals are converted into digital data. A first accumulation unit 21 accumulates (i.e., stores) each of the acquired process values P together with at least acquisition time information and ID information of the sensor 25 or control device 26 from which this process value P is outputted.

A learning unit 27 builds a model 28 that has been trained in the following manner. Of the stored process values P, normal process values P are compressed as input data, and output data are obtained by restoring the compressed data such that the output data match the input data. Aspects of such a model 28 include an autoencoder. In some cases, a pre-built model 28 is used. Thus, the learning unit 27 is not a required component of the plant monitoring support apparatus 10.

The autoencoder is a type of a neural network. An autoencoder means algorithm that compresses input data once to leave only important features and then restores the compressed data to its original dimensions as output data. This autoencoder receives input data at a node of an input layer and compresses the received input data into a hidden layer. At this time, the input data are weighted depending on its importance degree, and data with low scores or low importance degree are filtered out (i.e., encoding). At the time of transitioning to an output layer, weighting is also applied, and the sum of the data that the node has received from a plurality of edges becomes the output data as the final value (i.e., decoding). The learning unit 27 builds the model 28 (i.e., autoencoder) in such a manner that the output data match the input data.

The reproduction unit 16 outputs a reproduced value R (i.e., output data), which is obtained by performing data compression/restoration on the process value P (i.e., input data) acquired in real time from the monitoring target 20 on the basis of the model 28. In the first calculation unit 11, for each of the process values P such as the temperature and pressure, the difference between the process value P before input into the reproduction unit 16 and the reproduced value R after output from the reproduction unit 16 is calculated and outputted as the deviation D. The deviations D calculated and outputted are accumulated in the second accumulation unit 22 in time series so as to correspond to the respective process values P. Preferably, each deviation D is also accumulated in the second accumulation unit 22 by using common ID information and time information so as to be linked to the corresponding process value P accumulated in the first accumulation unit 21.

The detection unit 17 detects an anomaly sign of the monitoring target 20 on the basis of the preset threshold S and the deviations D. The threshold S is set for each of the plurality of process values P, and these threshold S are registered in advance in a registration unit (not shown). When the deviation D for at least one process value P to be acquired in real time exceeds the corresponding threshold S, it is determined that an anomaly sign is detected.

FIG. 2 is a graph illustrating the time series of deviations D of the process values. The second calculation unit 12 (FIG. 1) calculates the change amount V (V_{A}) of the deviation D (D_{A}) at the timing T at which the deviation D exceeds the threshold S (S_{A}) and an anomaly sign is detected. The second calculation unit 12 divides the time series data of the deviations D on the basis of the timing T. The change amount V is calculated by taking the difference between (i) an arbitrary value of the time series data of the deviations D after the division and (ii) an arbitrary value of the time series data of the deviations D before the division.

The calculated change amount V is desirably stored in a storage unit (not shown) by using common ID information and time information for each of the divided time series data of the process value P. The time series data of the deviations D can be divided by arbitrarily adjusting the time width forward or backward with respect to the timing T at which the anomaly sign is detected. This time width can be set differently or individually depending on the attribute of the process value P.

As shown in FIG. 2, the change amount V_{B} of the process value related to an anomaly is observed with a time delay from the change amount V_{A} of the process value for which the anomaly sign is detected.

On the basis of the change amount V of each of the plurality of process values, the selection unit 18 selects the process values P that are mutually interrelated and have different attributes 37.

FIG. 3 illustrates a screen of a display 29 that displays the change amount V and attributes 37 of the process values P that are mutually interrelated by an anomaly (including the process value P for which the anomaly sign has been detected). For example, the selection unit 18 can arbitrarily set the number of the process values P that exceed the threshold S and are displayed on the display 29. Additionally or alternatively, they may be set as process values P with large change amount regardless of the threshold S (the top 10 with the largest change amount are shown in the case of FIG. 3). Further, when the attributes 37 of process values mutually related are linked to each other in advance and an anomaly sign is detected in the attribute 37 of a certain process value, the attribute 37 of the linked process value may be displayed as a choice for the interrelated detection and the change amount V may be observed.

Although the display 29 displays the attribute 37 of the process values mutually interrelated to the anomaly such that their change amounts V are supplementarily displayed, the display 29 may also supplementarily display the process value P, the deviation D, the threshold S, and the timing T, for example. Although not illustrated in the drawings, a simple rank correlation coefficient between the attributes 37 of the process values may also be displayed.

In this manner, when an anomaly sign is detected in any one of the process values P, the display 29 displays not only this process value P for which the anomaly sign is detected but also other process values P to be interrelated by this process value P due to the anomaly. This configuration can give a stronger warning to an observer. This configuration further eliminates the influence of the process values which are the monitoring targets and have stationarily large deviations D, and enables the observer to accurately recognize the process values to be mutually interrelated by an anomaly.

### Second Embodiment

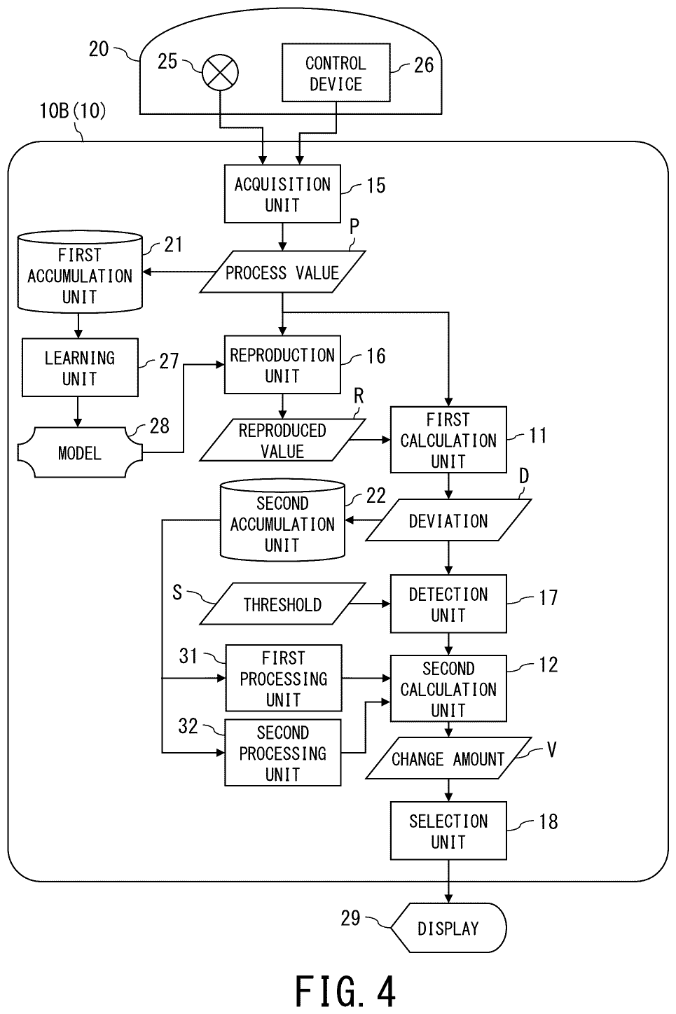

Next, the second embodiment of the present invention will be described by referring to FIG. 4. FIG. 4 is a configuration diagram illustrating a plant monitoring support apparatus 10B (10) according to the second embodiment. The plant monitoring support apparatus 10B of the second embodiment has a configuration in which a first processing unit 31 and a second processing unit 32 are further added to the configuration of the first embodiment described above. In FIG. 4, the components having the same configuration or function as those in FIG. 1 are denoted by the same reference signs, and duplicate descriptions are omitted.

The first processing unit 31 averages the deviations D in the process values P acquired before the timing T at which the anomaly sign is detected. The second processing unit 32 averages the deviations D in the process values P acquired after the timing T at which the anomaly sign is detected. The duration of the averaging processing of the first processing unit 31 is arbitrarily determined for each of the attributes 37 of the process values, and the same holds true for the duration of the averaging processing of the second processing unit 32.

In the second calculation unit 12, the change amount V is calculated by taking the difference between the deviation D averaged over a predetermined period before the timing T and the deviation D averaged over a predetermined period after the timing T. Accordingly, the configuration of the second embodiment can eliminate not only the influence of the process values with stationarily large deviations but also the influence of their noise and time delay, and thus, can enable the observer to highly accurately recognize the process values to be mutually interrelated by an anomaly.

### Third Embodiment

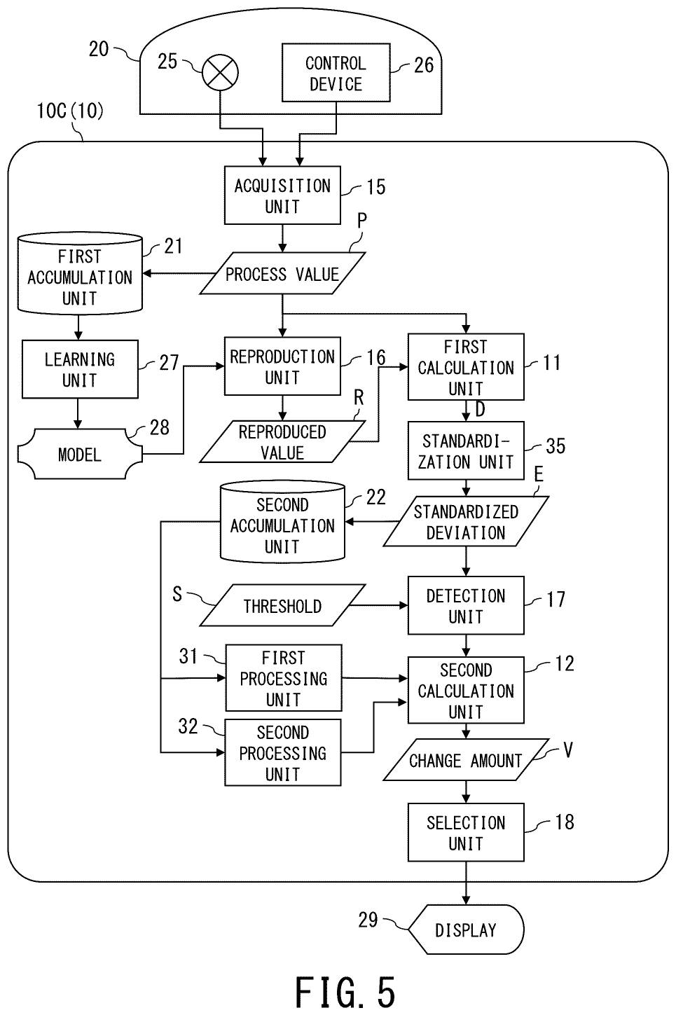

Next, the third embodiment of the present invention will be described by referring to FIG. 5. FIG. 5 is a configuration diagram illustrating a plant monitoring support apparatus 10C (10) according to the third embodiment. The plant monitoring support apparatus 10C of the third embodiment has a configuration in which a standardization unit 35 is further added to the configuration of the first embodiment and the second embodiment described above. In FIG. 5, the components having the same configuration or function as those in FIG. 1 or FIG. 4 are denoted by the same reference signs, and duplicate descriptions are omitted.

The standardization unit 35 standardizes each of the calculated deviations D so as to obtain a standardized deviation E. The standardized deviations E outputted from the standardization unit 35 are time-sequentially accumulated in the second accumulation unit 22 for each of the plurality of process values P. On the basis of the standardized deviations E, the detection unit 17 detects the process value P that shows an anomaly sign, and the selection unit 18 selects the process value(s) P to be mutually interrelated by an anomaly (FIG. 2).

The standardization unit 35 calculates the standardized deviation E by dividing the deviation D by the variation of the process values P. As the variation of the process values P to be used for the denominator of the division, the standard deviation of the process value P and/or the standard deviation of the deviation D used in the learning unit 27 is adopted. However, the denominator of the division to be used for the standardization is not limited to these variations in the process values P.

Accordingly, the configuration of the third embodiment can eliminate not only the influence of the process values with stationarily large deviations but also the influence of accidental change in the process values, and thereby can enable the observer to highly accurately recognize the process values to be mutually interrelated by an anomaly. The change amount V can be readily compared even between process values with different attributes 37 (for example, when the physical quantities to be measured are different, such as pressure and flow rate, or when the physical quantities are the same but the targets are different).

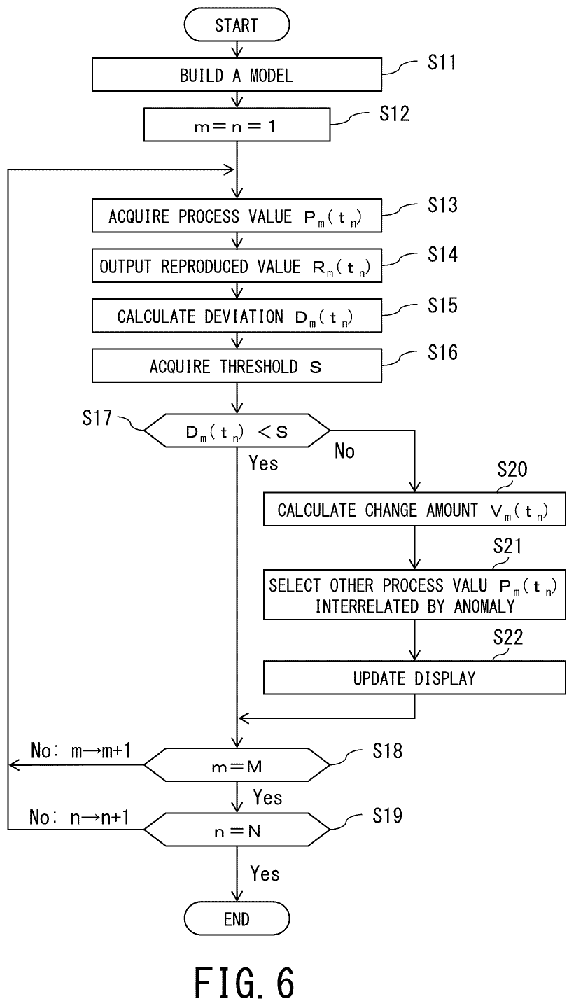

On the basis of the flowchart of FIG. 6, the steps of the plant monitoring support method and the algorithm of the plant monitoring support program will be described.

First, in the step S11, the trained model 28 is build in such a manner that: the normal values among the process values P for the monitoring targets 20 are compressed as input data; and the restored output data match the input data.

Next, the process values Pₘ(tₙ) of m=1 to M in total are acquired from the monitoring target 20 in a time series of n=1 to N. First, it is set to “m=1 and n=1” in the step S12, and the process value Pₘ(tₙ) is acquired in the step S13.

On the basis of the model 28, the process value Pₘ(tₙ) is subjected to data compression/restoration, and the reproduced value Rₘ(tₙ) is outputted in the step S14.

Next, the deviation Dₘ(tₙ) of the reproduced value Rₘ(tₙ) and the process value Pₘ(tₙ) is calculated in the step S15, then the preset threshold S is acquired in the step S16, and then both are compared in the step S17.

As long as the deviation Dₘ(tₙ) does not exceed the threshold S (YES in the step S17), the processing proceeds to the step S18 and thereby the loop of the steps S13 to S17 is run for another process value Pₘ₊₁(tₙ), and further, the loop of the steps S13 to S18 is run for the time-series process value Pₘ(tₙ₊₁) (S19; No, Yes, END).

If the deviation Dₘ(tₙ) exceeds the threshold S (No in the step S17), it means that an anomaly sign is detected, and the change amount Vₘ(tₙ) of the deviation Dₘ(tₙ) at this detection timing T is calculated in the step S20.

Further, the loop of the steps S13 to S17 is repeated in the same manner (S18: No, Yes), and another process value Pₘ₊₁(tₙ) to be mutually interrelated by an anomaly is selected on the basis of its change amount Vₘ₊₁(tₙ) in the step S21.

Additionally or alternatively, instead of using the threshold S, for example, the change amount Vₘ(tₙ) of the deviation Dₘ(tₙ) for the total process values is calculated in the step S20, and the process values to be mutually interrelated by an anomaly is selected as TOP10. The selected process amount is updated or added to the display contents on the display 29 in the step S22, and then, the loop of the steps S13 to S18 is run for the time-series process value Pₘ(tₙ₊₁) (S19; No, Yes, END).

According to the plant monitoring support apparatus of at least one embodiment described above, the process values to be related by an anomaly can be efficiently and highly reliably narrowed down by selecting the attributes of the process values mutually interrelated from the change amount of the deviations, which are calculated on the basis of the detection timing of the anomaly sign.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

The above-described plant monitoring support apparatus includes: a controller in which one or more processors such as a dedicated chip, an FPGA (Field Programmable Gate Array), a GPU (Graphics Processing Unit), and a CPU (Central Processing Unit) are highly integrated; a memory such as a ROM (Read Only Memory) and a RAM (Random Access Memory); an external storage device such as a HDD (Hard Disk Drive) and an SSD (Solid State Drive); a display; an input device such as a mouse and a keyboard; and a communication interface. The plant monitoring support apparatus can be realized by general computer-based hardware configuration. Thus, the components of the plant monitoring support apparatus can be achieved by a processor of a computer and can be operated by a plant monitoring support program.

The plant monitoring support program may be provided in the form of being pre-embedded in a ROM or a similar device. Additionally or alternatively, the plant monitoring support program can be provided as an installable format or an executable file stored in a computer-readable storage medium such as a CD-ROM, a CD-R, a memory card, a DVD, and a flexible disk (FD).

Moreover, the plant monitoring support program according to the present embodiment may be stored on a computer connected to a network such as the Internet so as to be provided by being downloaded via the network. Furthermore, the plant monitoring support apparatus can also be configured by interconnecting separate modules, which independently achieve the respective functions of the components, via a network or dedicated lines and combining these modules such that these modules work in combination.

What is claimed is:

1. A plant monitoring support apparatus comprising:
an acquisition unit configured to acquire process values of a monitoring target;
a reproduction unit configured to output a reproduced value obtained by using a model for performing data compression/restoration on the process values acquired in real time;
a first calculation unit configured to calculate deviations of the process values and the reproduced value;
a detection unit configured to detect an anomaly sign of the monitoring target depending on a preset threshold and the deviations;
a second calculation unit configured to calculate change amount of the deviations depending on a timing at which the anomaly sign is detected; and
a selection unit configured to use the change amount for selecting a process value that belongs to another attribute and interrelated to the anomaly.

2. The plant monitoring support apparatus according to claim 1, further comprising:
a first processing unit configured to average the deviations in the process values acquired before the timing at which the anomaly sign is detected; and
a second processing unit configured to average the deviations in the process values acquired after the timing at which the anomaly sign is detected,
wherein the change amount is calculated by using the deviations subjected to averaging.

3. The plant monitoring support apparatus according to claim 1, further comprising a standardization unit configured to standardize calculated deviations to obtain standardized deviations,
wherein detection of the anomaly sign and selection of the anomaly interrelated are performed depending on the standardized deviations.

4. The plant monitoring support apparatus according to claim 1, further comprising a learning unit configured to cause a model to learn in such a manner that: normal values of the process values are compressed as input data; and restored output data match the input data.

5. The plant monitoring support apparatus according to claim 1, further comprising a display configured to display an attribute of a process value to be interrelated by an anomaly.

6. A plant monitoring support method comprising steps of:
acquiring process values of a monitoring target;
outputting a reproduced value obtained by using a model for performing data compression/restoration on the process values acquired in real time;
calculating deviations of the process values and the reproduced value;
detecting an anomaly sign of the monitoring target depending on a preset threshold and the deviations;
calculating change amount of the deviations depending on a timing at which the anomaly sign is detected; and
using the change amount for selecting a process value that belongs to another attribute and interrelated to the anomaly.

7. A computer-readable plant monitoring support program that allows a computer to perform:
an acquisition process of acquiring process values of a monitoring target;
an output process of outputting a reproduced value obtained by using a model for performing data compression/restoration on the process values acquired in real time;
a calculation process of calculating deviations of the process values and the reproduced value;
a detection process of detecting an anomaly sign of the monitoring target depending on a preset threshold and the deviations;
another calculation process of calculating change amount of the deviations depending on a timing at which the anomaly sign is detected; and
a selection process of using the change amount for selecting a process value that belongs to another attribute and interrelated to the anomaly.
